(19) United States
(12) Patent Application Publication
(10) Pub. No.: US 2025/0013435 A1
(43) Pub. Date: Jan. 9, 2025

(54) USING LARGE LANGUAGE MODEL(S) FOR DIGITAL PRODUCT DELIVERY

(71) Applicant: Chevron U.S.A. Inc., San Ramon, CA (US)

(72) Inventor: Larry A. Bowden, JR., Houston, TX (US)

(21) Appl. No.: 18/348,305

(22) Filed: Jul. 6, 2023

(51) Int. Cl. G06F 8/30; G06F 8/10; G06F 11/36; G06F 40/30

(52) U.S. Cl. CPC G06F 8/30; G06F 8/10; G06F 11/3688; G06F 40/30

(57) ABSTRACT

A system for generating and delivering a digital product is described including one or more processors; non-transitory computer readable media; and one or more programs including instructions that when executed by the one or more processors cause the system to receive a list of roles and desired features for the digital product; provide the list to a large language model (LLM) configured to summarize actions for each role based on the desired features; generate a set of instructions for each action for each role; and generate content for each set of instructions.

### TECHNICAL FIELD

The disclosed embodiments relate generally to a system and process for efficiently generating and delivering digital products. In particular, the system and process make use of large language models to improve the generation and delivery of digital products.

### BACKGROUND

As large language models become more advanced, they are able to generate algorithms and applications from text descriptions with increased accuracy, efficiency, and quality. This capability can revolutionize the way digital product delivery is conducted.

Traditionally, digital product delivery management involves teams of developers, designers, and product managers working together to create a product roadmap and deliver new features and updates in a series of iterations, or sprints. This process often involves extensive collaboration, communication, and documentation to ensure the team is aligned on the goals and requirements of each iteration.

There exists a need for effective and efficient digital product delivery.

### SUMMARY

In accordance with some embodiments, a method of digital product delivery including receiving a list of roles and desired features for the digital product; providing the list to a large language model (LLM) configured to summarize actions for each role based on the desired features; generate a set of instructions for each action for each role; and generate content for each set of instructions is disclosed. The method may further include displaying one or more of the actions for each role, the set of instructions for each action for each role, or the content for each set of instructions on a graphical display. In another embodiment, the method may have a user validate the one or more of the actions for each role, the set of instructions for each action for each role, or the content for each set of instructions displayed on the graphical display and the method may test the content for each set of instructions to generate tested content. The method may provide the tested content as the digital product.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates an example system for digital product delivery;

FIG. 2 is an example process for delivering digital products;

FIG. 3A illustrates an example of a step of a process for delivering digital products;

FIG. 3B illustrates an example of a step of a process for delivering digital products;

FIG. 3C illustrates an example of a step of a process for delivering digital products;

FIG. 3D illustrates an example of a step of a process for delivering digital products;

FIG. 3E illustrates an example of a step of a process for delivering digital products; and

FIG. 4 illustrates an example output of a step for delivering digital products.

Like reference numerals refer to corresponding parts throughout the drawings.

### DETAILED DESCRIPTION OF EMBODIMENTS

Described below are methods, systems, and computer readable storage media that provide a manner of digital product delivery. These embodiments are designed to use large language model(s) to deliver digital products more efficiently and consistently.

The collaboration between teams of developers, designers, and product managers can be automated with use of large language models to generate algorithms and applications from descriptions, using prompt engineers. The output can be validated and tested by software engineers to validate and create features, updates, etc.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

The methods and systems of the present disclosure may, in part, use one or more models that are machine-learning algorithms. These models may be large language models (LLMs). LLMs are trained using large datasets of text, such as books, articles, or conversations. The datasets are used to create a language model that can generate text that is similar to the text in the dataset. The model is then fine-tuned using supervised and reinforcement learning techniques. Supervised learning techniques involve providing the model with labeled examples of desired output and using these examples to train the model. Reinforcement learning techniques involve providing the model with rewards for generating output that is similar to the desired output. The model is then able to generate text that is more accurate and more closely resembles the desired output. In an embodiment, an LLM may be trained using a combination of supervised learning, comparison learning, and reinforcement learning. In an embodiment, the LLM is trained using supervised learning. This involves collecting demonstration data and training a supervised policy. A prompt can be sampled from a prompt dataset then a labeler demonstrates the desired output, thereby generating a supervised fine-tuned (SFT) model. Next, the model can be further trained using comparison learning. This requires a labeler to rank outputs from the SFT from best to worst. This information is used to train a reward model. Lastly, reinforcement learning is used to update the reward model. Proximal Policy Optimization (PPO) is a commonly used reinforcement learning algorithm for this purpose. Using these steps for the training reduces bias in the LLM. Examples of LLMs include OpenAI's GPT models and Google's Bard model but these are not meant to be limiting. Although the present disclosure may name specific models, those of skill in the art will appreciate that any LLM that may accomplish the goal may be used.

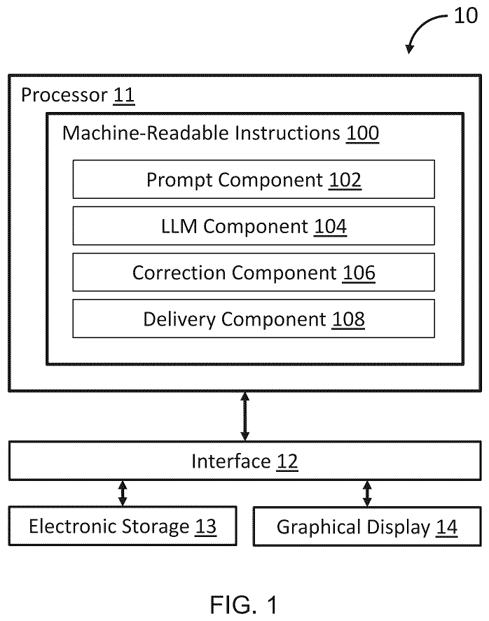

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a graphical display 14, and/or other components. The processor 11 will receive prompts from a user and execute one or more of the methods described herein to aid in the delivery of digital products.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store information relating to input prompts, and/or other information. For example, the electronic storage 13 may store information relating to LLM output, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may include one or more non-transitory computer readable storage medium storing one or more programs. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to LLM output, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate digital product delivery. The machine-readable instructions 100 may include one or more computer program components. The machine-readable instructions 100 may include a prompt component 102, a LLM component 104, a correction component 106, a delivery component 108, and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more in functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the prompt component 102 may be configured to receive prompts from the user.

The LLM component 104 may be configured to present prompts to the LLM which will generate the requested LLM output.

The correction component 106 may be configured to present LLM output to a user and receive corrections from the user. It may further provide the corrections to the LLM component 104 in order to receive corrected LLM output.

The delivery component 108 may be configured to present the LLM output to the electronic storage 13 and/or the graphical display 14.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

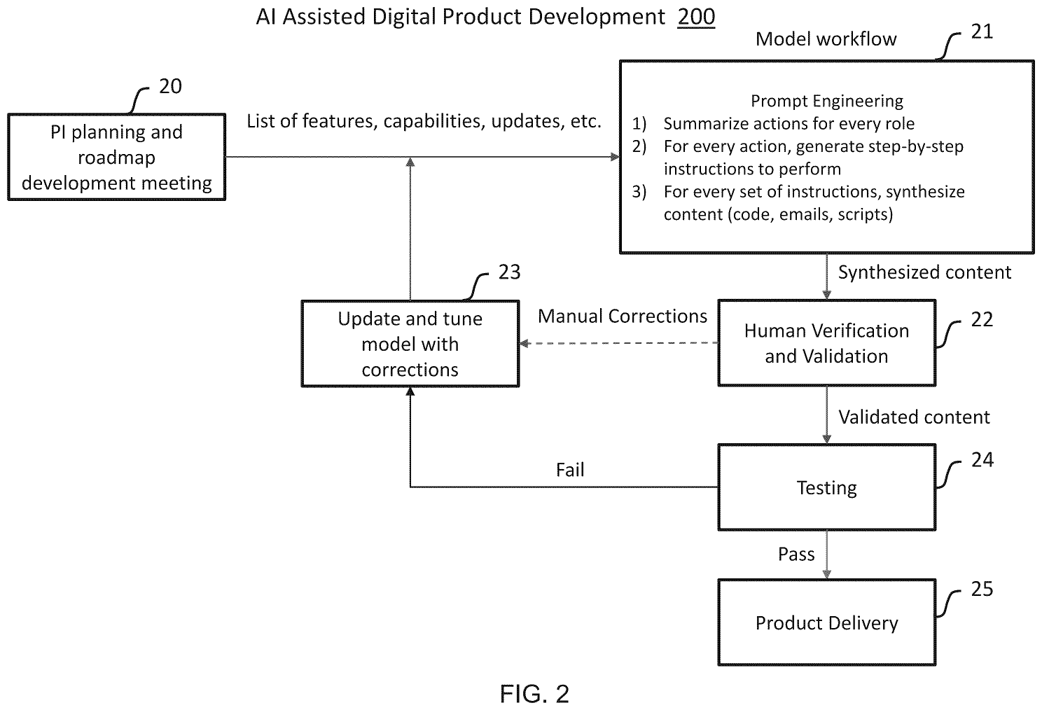

FIG. 2 illustrates an example process 200 for digital product delivery. Step 20 is a meeting for the Program Increment (PI) planning and roadmap development including identification of the roles needed to develop the digital product. This meeting will generate a list of features, desired capabilities, desired updates, etc. for the digital product. In an embodiment, this meeting may be recorded, and the recording may be provided to step 21 wherein a transcript is generated and provided to a LLM that will generate a list of action items for each role. The LLM will then further generate a set of step-by-step instructions for each action item and synthesis content for set of instructions. The content may be, for example, computer code, email messages, and/or scripts or the like.

The synthesized content from the LLM may then be reviewed by a human for verification and validation at step 22. The human may make manual corrections at can optionally be used at step 23 to update and tune the model, then repeat step 21. Validated content from step 22 is passed to step 24 for testing. The testing may include, by way of example and not limitation, any of the following:
1. Test the accuracy of the model by providing it with labeled examples of desired output and comparing the output of the model to the desired output.
2. Test the effectiveness of the reinforcement learning techniques by providing the model with rewards for generating output that is similar to the desired output and comparing the output of the model to the desired output.
3. Test the ability of the model to generate text that is similar to the text in the dataset by providing the model with examples of text from the dataset and comparing the output of the model to the text in the dataset.
4. Test the ability of the model to generate text that is similar to the desired output by providing the model with examples of the desired output and comparing the output of the model to the desired output.
   If the testing fails, the process may perform step 23, 21, 22, and 24 again until the content passes and the product is delivered at step 25.

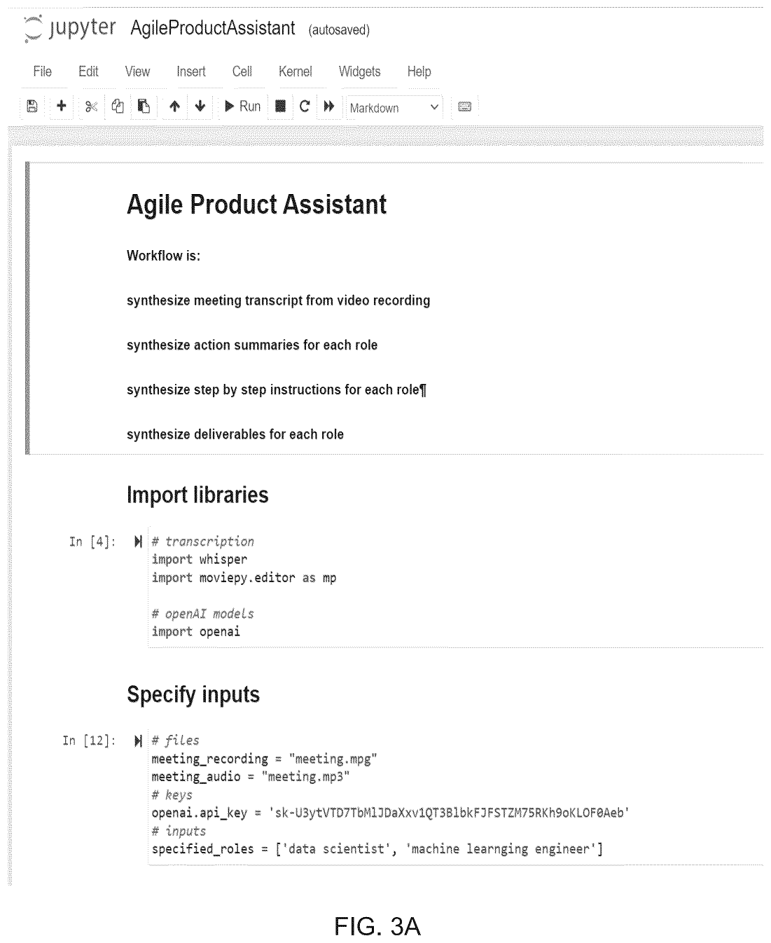

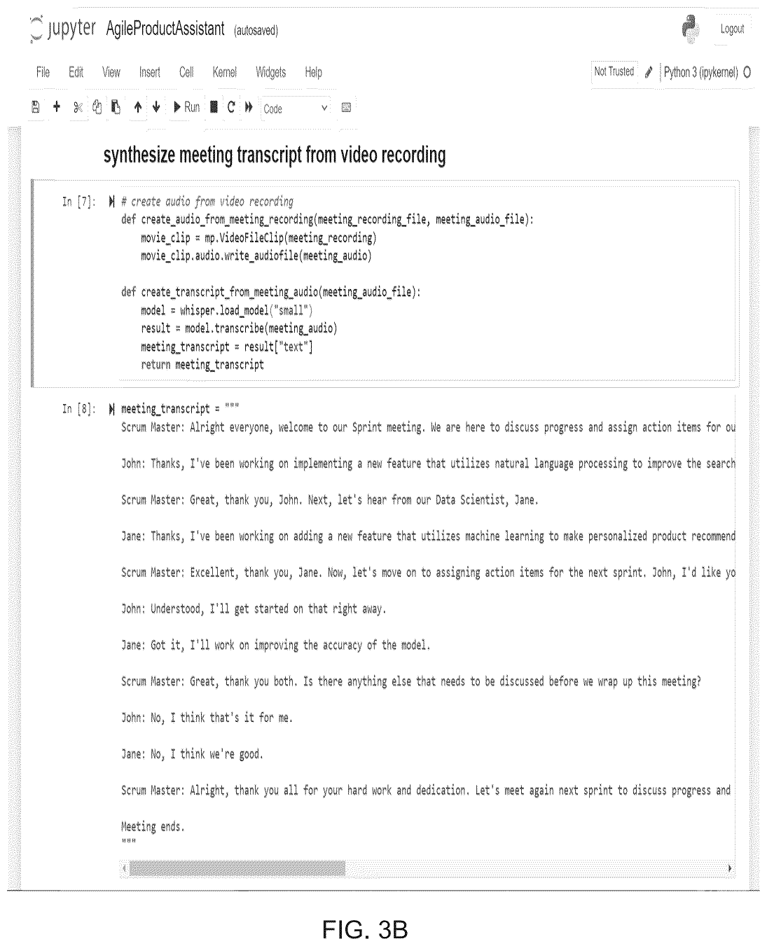

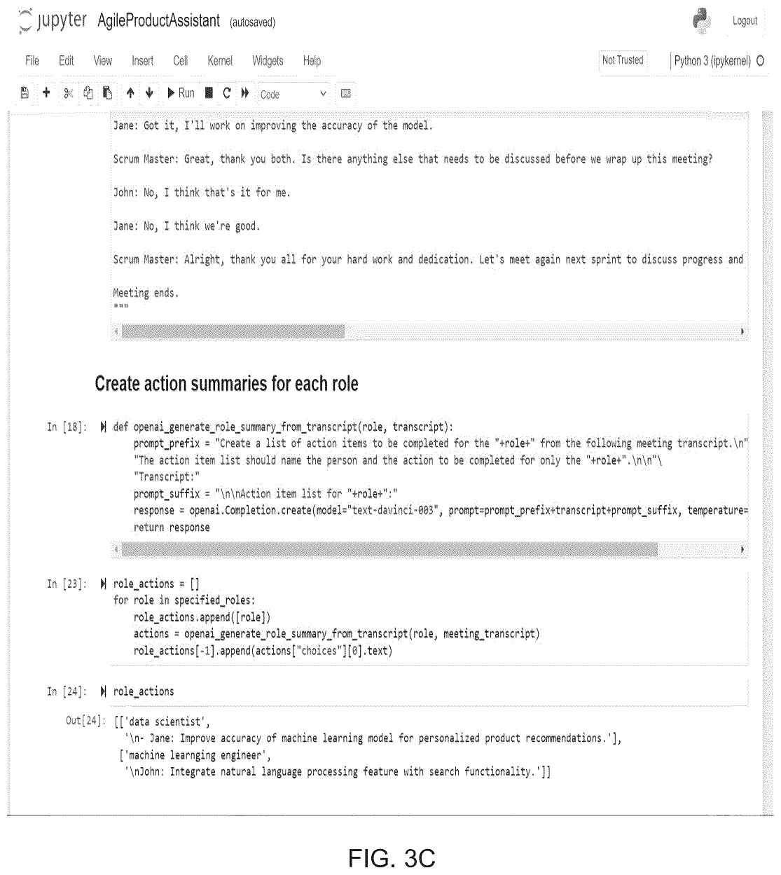

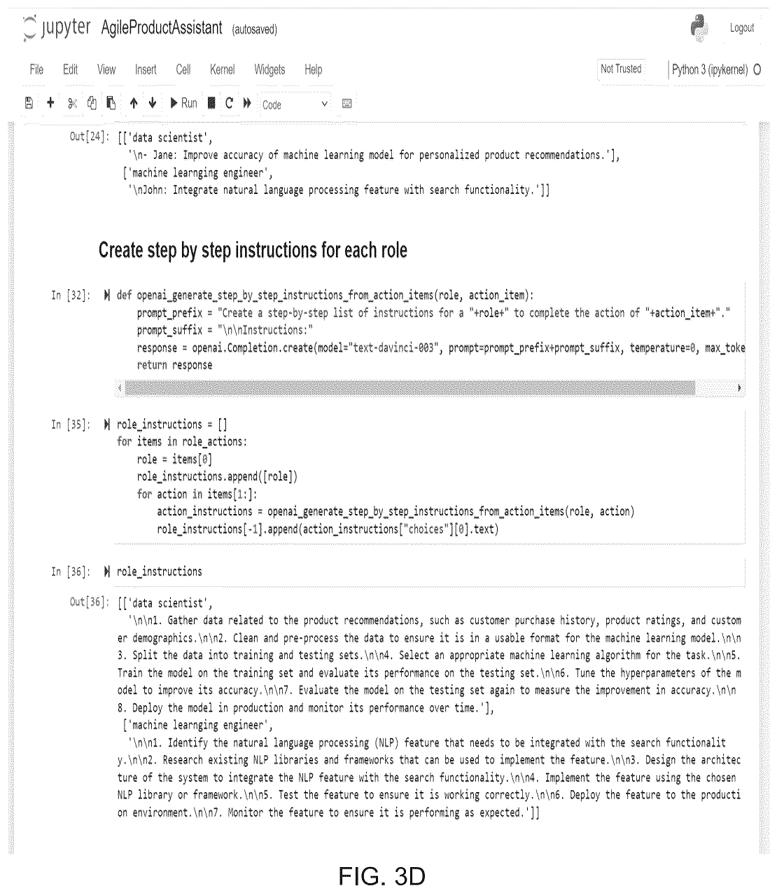

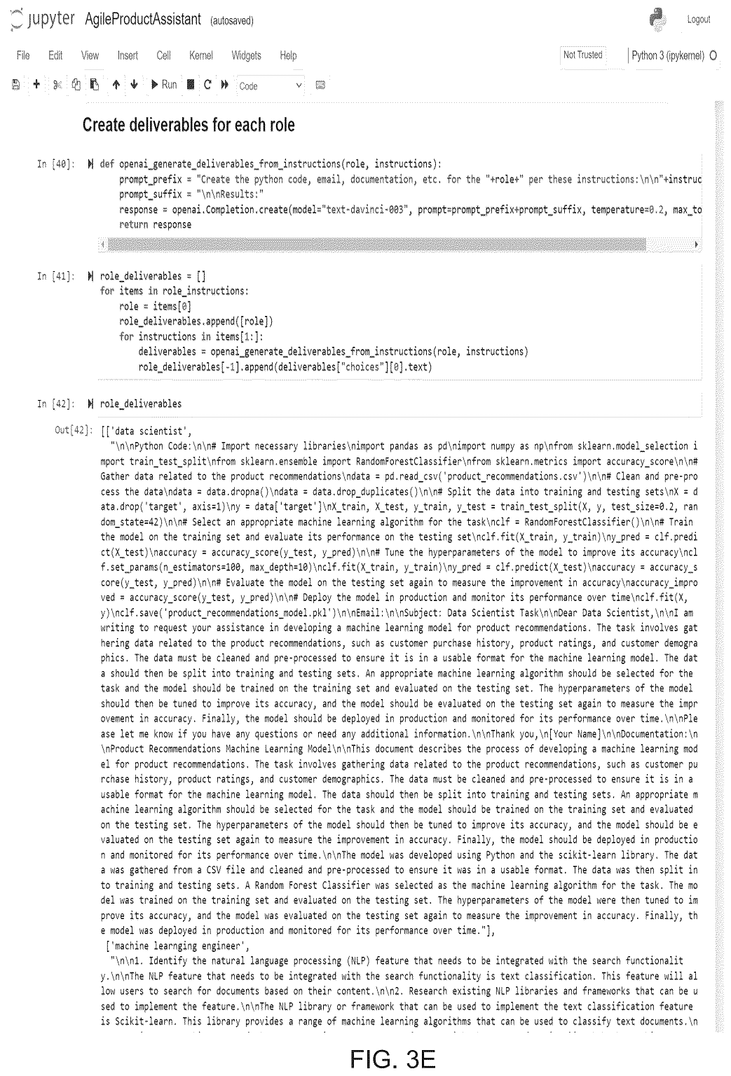

FIG. 3A-3E demonstrates an example of step 21 of process 200 beginning with a transcript of a planning meeting and specified roles (FIG. 3A and FIG. 3B). Based on that transcript, action summaries for each role are generated (FIG. 3C) and step-by-step instructions are generated (FIG. 3D). Based on the instructions, deliverables for each role are generated (FIG. 3E).

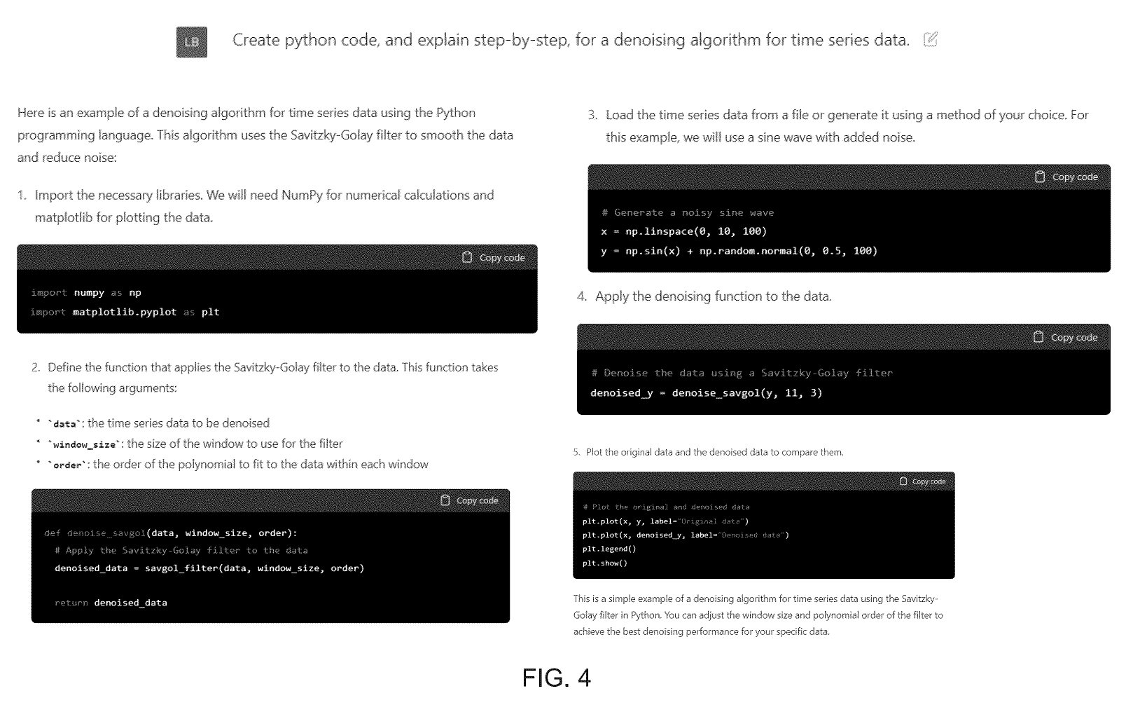

FIG. 4 demonstrates an example of how an LLM can generate code to fulfill one of the instructions generated by step 21. This code would be then validated (step 22) and tested (step 24).

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes.” “including.” “comprises,” and/or “comprising.” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A system for delivering a digital product, comprising:
one or more processors;
non-transitory computer readable media; and
one or more programs, wherein the one or more programs are stored in the non-transitory computer readable media and configured to be executed by the one or more processors, the one or more programs including instructions that when executed by the one or more processors cause the system to:
a) receive a list of roles and desired features for the digital product;
b) provide the list to a large language model (LLM) configured to:
i) summarize actions for each role based on the desired features;
ii) generate a set of instructions for each action for each role; and
iii) generate content for each set of instructions.

2. The system of claim 1, further comprising a graphical display and additional instructions that when executed by the one or more processors cause the system to display one or more of the actions for each role, the set of instructions for each action for each role, or the content for each set of instructions on the graphical display.

3. The system of claim 2 wherein a user validates the one or more of the actions for each role, the set of instructions for each action for each role, or the content for each set of instructions displayed on the graphical display and further executes instructions that when executed by the one or more processors cause the system to test the content for each set of instructions to generate tested content.

4. The system of claim 3 wherein the tested content is output as the digital product and is stored in the non-transitory computer readable media.

5. A computer-implemented method of digital product delivery, comprising:
a) receiving a list of roles and desired features for the digital product;
b) providing the list to a large language model (LLM) configured to:
i) summarize actions for each role based on the desired features;
ii) generate a set of instructions for each action for each role; and
iii) generate content for each set of instructions.

6. The method of claim 5, further comprising displaying one or more of the actions for each role, the set of instructions for each action for each role, or the content for each set of instructions on a graphical display.

7. The method of claim 6 wherein a user validates the one or more of the actions for each role, the set of instructions for each action for each role, or the content for each set of instructions displayed on the graphical display and the method further comprises testing the content for each set of instructions to generate tested content.

8. The method of claim 7 wherein the tested content is output as the digital product and is stored in non-transitory computer readable media.
